(19) United States
(12) Patent Application Publication
(10) Pub. No.: US 2015/0348503 A1
(43) Pub. Date: Dec. 3, 2015

(54) APPARATUS AND METHOD FOR COLOR ADJUSTMENT OF CONTENT

(71) Applicant: KOREA ADVANCED INSTITUTE OF SCIENCE AND TECHNOLOGY, Daejeon (KR)

(72) Inventors: Sung Ju Woo, Chungcheongnam-do (KR); Chong Wook Park, Daejeon (KR)

(21) Appl. No.: 14/613,424

(22) Filed: Feb. 4, 2015

(30) Foreign Application Priority Data
May 28, 2014 (KR) 10-2014-0064186

(51) Int. Cl. G09G 5/06

(52) U.S. Cl. CPC G09G 5/06; G09G 2320/0666; G09G 2340/06; G09G 2354/00

(57) ABSTRACT

Disclosed is an apparatus and method for color adjustment of content, and the apparatus for color adjustment of content includes a color transformation criteria database to store and manage color transformation criteria corresponding to each of combinations of types of color blindness and emotions, a data input unit to obtain a type of color blindness of a user and information associated with a target emotion, a color transformation criterion acquisition unit to acquire a color transformation criterion corresponding to the type of color blindness of the user and the target emotion by searching the color transformation criteria database, and a content color adjusting unit to perform a content color adjusting operation based on the acquired color transformation criterion.

### CROSS-REFERENCE TO RELATED APPLICATION

This application claims priority of Korean Patent Application No. 10-2014-0064186, filed on May 28, 2014, in the KIPO (Korean Intellectual Property Office), the disclosure of which is incorporated herein entirely by reference.

### BACKGROUND OF THE INVENTION

1. Field of the Invention

The present disclosure relates to technology for color adjustment of content, and more particularly, to an apparatus and method for color adjustment of content that allows people with color blindness to feel emotions with minimized distortion from emotions people with normal color vision feel.

2. Description of the Related Art

Color blindness is the inability or limited ability to distinguish colors, called anomalous trichromacy and dichromacy, respectively. Color blindness occurs by large and small faults and defects in the functions of three types of cone cells, R(ed), G(reen), and B(lue) cones, and may be classified into inherited color blindness and acquired color blindness caused by diseases or accidents. The type and degree of inherited color blindness is unchanged for life.

The condition in which any one of three types of cone cells R, G, and B is missing is known as dichromacy, and the condition in which all three types of cone cells are present but one of them does not function normally is known as anomalous trichromacy (Young-Ju Shin et al., 2006: 1638), and color blindness is categorized into three types such as protanomaly, deuteranomaly, and tritanomaly.

A first type of color blindness, protanomaly, is denoted as ‘p’-type, and people with protanomaly see reds as browns, and understand information and feel emotional. A second type of color blindness, deuteranomaly, which is classified as ‘d’-type, is not greatly different from protanomaly in that greens are seen as browns.

By this reason, studies on protanomaly and deuteranomaly are often made collectively as red-green color blindness. Tritanomaly, which is a third type of color blindness, is classified as ‘t’-type. The incidence of tritanomaly is very rare and is not gender-linked (Young-Ju Shin et al., 2004: 2099). Tritanomaly is characterized by pink-tinged color vision. The color blindness occurs in degrees, and may be classified into ‘slight’, ‘moderate’, and ‘severe’ based on degree.

The color sensibility of people with color blindness is different from that of people with normal color vision. It is because people with color blindness see and perceive colors essentially differently from people with normal color vision. This difference induces a difference in emotional reaction to color, and providing of information through colors leads to information distortion and emotional distortion.

In this instance, distortion should not be extended to the cause of ‘discrimination’, and needs to be only interpreted as an objective ‘difference’ in information and emotion. It is because distortion in the structure of conveyance of the meaning of content created by the medium of colors and communication and conveyance of emotion contained in the content is not a matter of determining whether it is right or wrong, and just implies a difference in the method of seeing and perceiving.

The problem lies in the fact that the bond of sympathy for color tends to form by the unit of social and cultural condition and environment, and a lot of contents are created in a prevailing situation in which such awareness is shared. It is because people with color blindness may not sympathize with color psychology recognized as being general and common and its related color preferences and taste tendencies.

In the modern western medicine, color blindness is not yet considered to be treated. As opposed to that vision may change based on variables such as environment and time, it is found that the type and degree of color blindness never change. As time goes by, people with color blindness are gradually accustomed to their surrounding situation and environment, so children and teenagers experience inconvenience and sense of difference much more than older adults.

A difference in sensory perception of colors may lead to a difference in cognition. In contrast with sensibility people with normal color vision feel and their emotion and an extent of cognition when they see a green-blue fresh salad, people with protanomaly and deuteranomaly see a dark brown or blackish brown salad and experience an emotional distortion related to colors.

Through comprehensive impressions and images including the sense of smell and the sense of touch and determination of texture, it is also possible to distinguish a salad which turned brown or a rotten salad from a fresh salad, but its process is complex. It is because information and emotion is transmitted and perceived ‘differently’. This is why investigation and research is needed to verify color sensibility people with color blindness feel. A survey on the real condition about color sensibility people with color blindness feel differently and how different it is and its results lead to not only expansion of social and cultural awareness, but also a practical effect of setting the direction of color transformation that may be concretely used in creating content, and will be essential requirements to construct public culture service infrastructure in consideration of emotions of people with color blindness and increase the added value of domestic and global cultural content industry.

The use of cultural content by the medium of a computer environment is increasing day by day, but in practice, there is scarcely found a case in which content is created and provided in favor of people with color blindness. Thus, there is still an inconvenience that causes to people with color blindness feeling emotions differently from people with normal color vision when seeing the same content.

Therefore, there was a need for technology for emotional distortion of people with color blindness, and for example, Korean Patent Application No. 10-2004-0080668 proposed technology for emotional distortion of people with color blindness, but just discloses a concept of minimizing an emotional distortion of people with color blindness by generating and utilizing color vision deficiency correction information and has a limitation in that it fails to explain a specific solution.

### SUMMARY OF THE INVENTION

The present disclosure is designed to address the above issue, and therefore, the present disclosure is directed to providing an apparatus and method for color adjustment of content that may minimize distortion occurring to emotions people with color blindness feel.

The object of the present disclosure is not limited to the above object, and other objects of the present disclosure not described in the foregoing will become apparent to those skilled in the art from the following description.

According to an exemplary embodiment of the present disclosure, there is provided an apparatus for color adjustment of content including a color transformation criteria database to store and manage color transformation criteria corresponding to each of combinations of types of color blindness and emotions, a data input unit to obtain a type of color blindness of a user and information associated with a target emotion, a color transformation criterion acquisition unit to acquire a color transformation criterion corresponding to the type of color blindness of the user and the target emotion by searching the color transformation criteria database, and a content color adjusting unit to perform a content color adjusting operation based on the acquired color transformation criterion.

The color transformation criteria database may further include a function of storing and managing surrounding color transformation criteria corresponding to each of color combinations for each emotion and each type of color blindness.

The content color adjusting unit may transform a color to be transformed and a surrounding color of the color to be transformed together, based on the surrounding color transformation criteria corresponding to each of color combinations.

The color transformation criteria database may further include a function of storing and managing common color transformation criteria for each type of color blindness.

The color transformation criterion acquisition unit may acquire and provide, as the common color transformation criteria, a color transformation equation

$${}_{}^{``}{Hue}{}_{shift}^{} = {Hue}_{row} + \frac{2.3}{44} \times {( {Hue}_{row} - 76 )}^{″}$$

when the user has slight P-type color blindness, a color transformation equation

$${}_{}^{``}{Hue}{}_{shift}^{} = {Hue}_{row} + \frac{6}{44} \times {( {Hue}_{row} - 76 )}^{″}$$

when the user has moderate P-type color blindness, a color transformation equation

$${}_{}^{``}{Hue}{}_{shift}^{} = {Hue}_{row} + \frac{9}{44} \times {( {Hue}_{row} - 76 )}^{″}$$

when the user has severe P-type color blindness, a color transformation equation

$${}_{}^{``}{Hue}{}_{shift}^{} = {Hue}_{row} + \frac{4}{44} \times {( {Hue}_{row} - 76 )}^{″}$$

when the user has slight D-type color blindness, a color transformation equation

$${}_{}^{``}{Hue}{}_{shift}^{} = {Hue}_{row} + \frac{9.5}{44} \times {( {Hue}_{row} - 76 )}^{″}$$

when the user has moderate D-type color blindness, and a color transformation equation

$${}_{}^{``}{Hue}{}_{shift}^{} = {Hue}_{row} + \frac{11}{44} \times {( {Hue}_{row} - 76 )}^{″}$$

when the user has severe D-type color blindness, where Hue_{row} denotes a color before transformation, and Hue_{shift} denotes a color after transformation.

The apparatus for color adjustment of content may further include a content analysis unit to receive and analyze the content, divide the content into a plurality of sections based on a content of the content, and derive emotions representing each of the plurality of sections.

The content color adjusting unit may further include a function of differing in the color transformation criteria corresponding to each of the plurality of sections based on emotions representing each of the plurality of sections.

According to another exemplary embodiment of the present disclosure, there is provided a method for color adjustment of content including identifying a type and a degree of color blindness of a user, and acquiring a common color transformation criterion corresponding to the identified type and degree of color blindness, and adjusting and outputting the color of an inputted content based on the acquired common color transformation criterion.

The acquiring of the common color transformation criterion may include acquiring and providing, as the common color transformation criterion, a color transformation equation

$${}_{}^{``}{Hue}{}_{shift}^{} = {Hue}_{row} + \frac{2.3}{44} \times {( {Hue}_{row} - 76 )}^{″}$$

when the user has slight P-type color blindness, a color transformation equation

$${ }^{``} {Hue}_{shift} = {Hue}_{row} + \frac{6}{44} \times {( {Hue}_{row} - 76 )}^{″}$$

when the user has moderate P-type color blindness, a color transformation equation

$${ }^{``} {Hue}_{shift} = {Hue}_{row} + \frac{9}{44} \times {( {Hue}_{row} - 76 )}^{″}$$

when the user has severe P-type color blindness, a color transformation equation

$${ }^{``} {Hue}_{shift} = {Hue}_{row} + \frac{4}{44} \times {( {Hue}_{row} - 76 )}^{″}$$

when the user has slight D-type color blindness, a color transformation equation

$${ }^{``} {Hue}_{shift} = {Hue}_{row} + \frac{9.5}{44} \times {( {Hue}_{row} - 76 )}^{″}$$

when the user has moderate D-type color blindness, and a color transformation equation

$${ }^{``} {Hue}_{shift} = {Hue}_{row} + \frac{11}{44} \times {( {Hue}_{row} - 76 )}^{″}$$

when the user has severe D-type color blindness, where Huerow denotes a color before transformation, and Hueshift denotes a color after transformation.

As such, the present disclosure performs a content color adjusting operation in consideration of at least one a type of color blindness of a user, a target emotion, and a degree of color blindness, to minimize a phenomenon in which people with color blindness see the same content but feel differently from people with normal color vision.

Also, the present disclosure may artificially adjust emotions people should feel through content, through the content color adjusting operation.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a diagram illustrating an apparatus for color adjustment of content according to an exemplary embodiment of the present disclosure.

FIG. 2 is a diagram illustrating an example of a color transformation criteria database of an apparatus for color adjustment of content according to an exemplary embodiment of the present disclosure.

FIG. 3 is a diagram illustrating a method for color adjustment of content according to an exemplary embodiment of the present disclosure.

FIG. 4 is a diagram illustrating an apparatus for color adjustment of content according to another exemplary embodiment of the present disclosure.

FIG. 5 is a diagram illustrating an example of performing a content color adjusting operation differently for each section, by an apparatus for color adjustment of content according to another exemplary embodiment of the present disclosure.

FIG. 6 is a diagram illustrating an apparatus for color adjustment of content according to still another exemplary embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

For reference, as a result of presenting, to each of a normal group, a protanomaly group, and a deuteranomaly group, universal colors serving as a reference of a color wheel, for example, Munsell's five primary colors, red, yellow, green, blue, and purple and five intermediate colors, orange, yellow-green, blue-green, purple-blue, and red-purple, and then asking emotions they felt, results shown in Tableland Table 2 were obtained.

In this instance, Table 1 is a table summarizing established subjective colors based on emotions of people with color blindness, and Table 2 is a reference table of priority colors based on emotional tendencies by types of people with color blindness.

TABLE 1

| | Favorite | Happy | Intimate | Unfavorite | Sad | Reluctant | Active | Passive |
|---|---|---|---|---|---|---|---|---|
| | color | color | color | color | color | color | color | color |
| Normal | Blue | Yellow | Green | Blue | Purple | Blue | Red | Blue |
| | | | | green | blue | green | | green |
| Pro- | Blue | Yellow | Blue | Blue | Red | Blue | Red | Purple |
| tanomaly | | | | green | purple | green | | blue |
| Deuter- | Blue | Yellow | Yellow | Orange | Red | Blue | Red | Purple |
| anomaly | | green | green | | purple | green | | |

TABLE 2

| | Favorite | Happy | Intimate | Unfavorite | Sad | Reluctant | Active | Passive |
|---|---|---|---|---|---|---|---|---|
| | color | color | color | color | color | color | color | color |
| Pro- | Blue | Yellow > | Blue | Blue | Red | Blue | Red | Purple |
| tanomaly | | Yellow | | green > | purple | green | | blue |
| | | green | | Purple | | | | |
| | | | | blue | | | | |
| Deuter- | Blue > | Yellow | Yellow | Orange > | Red | Blue | Red | Purple > |
| anomaly | Yellow | green > | green > | Blue | purple > | green > | | Orange = |
| | green | Yellow | Blue | green | Blue | Red | | Green = |
| | | | | | green | purple | | Yellow |

That is, it can be seen that people with P-type color blindness and people with D-type color blindness see a content of the same color but feel different emotions.

Therefore, based on the above tables, the present disclosure is intended to provide an apparatus and method for color adjustment of content that dynamically adjusts the color of the content based on types of color blindness and emotions people with color blindness intend to feel (or should feel) through the corresponding content, to allow people with various types of color blindness to feel distortion-free emotions.

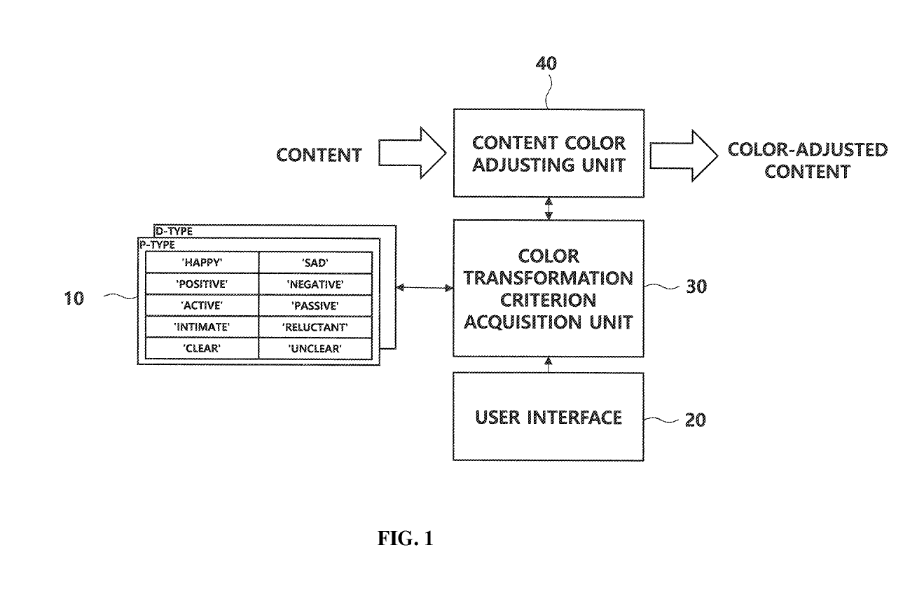

FIG. 1 is a diagram illustrating an apparatus for color adjustment of content according to an exemplary embodiment of the present disclosure.

As shown in FIG. 1, the apparatus for color adjustment of content according to the present disclosure includes a color transformation criteria database (DB) 10, a data input unit 20, a color transformation criterion acquisition unit 30, and a content color adjusting unit 40.

Hereinafter, a detailed of functions of each component is provided as below.

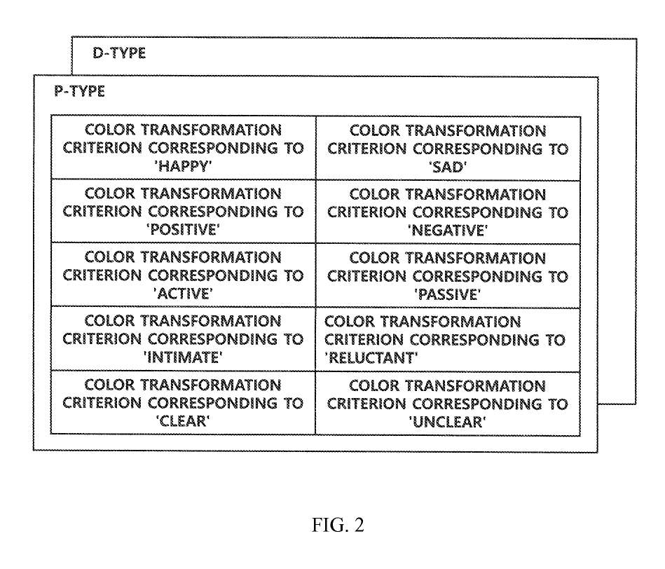

The color transformation criteria DB 10 pre-acquires and stores color transformation criteria corresponding to each of combinations of types of color blindness and emotions (for example, happy, sad, positive, negative, active, passive, intimate, reluctant, clear, and unclear), as shown in FIG. 2.

The data input unit 20 has a user interface such as a keyboard and a touch screen to allow a user to perform a data input operation, and through this, obtains a type of color blindness of the user and information associated with an emotion, hereinafter referred to as a target emotion, the user intends to obtain (or can obtain) when the user sees a content.

If the content further includes information associated with an emotion representing the corresponding content in addition to information necessary for playing the content, the data input unit 20 analyzes the information included in the content to recognize the information associated with the target emotion.

The color transformation criterion acquisition unit 30 acquires a color transformation criterion corresponding to the type of color blindness of the user and the target emotion by searching the color transformation criteria DB 10.

The content color adjusting unit 40 adjusts the color of the content based on the color transformation criterion detected through the color transformation criterion acquisition unit 30.

The content color adjusting operation of the content color adjusting unit 40 may be performed on the entire content at one time, and may be selectively performed on an object selected by the user. In this instance, the object may be various types of characters, various types of objects, and a background included in the content.

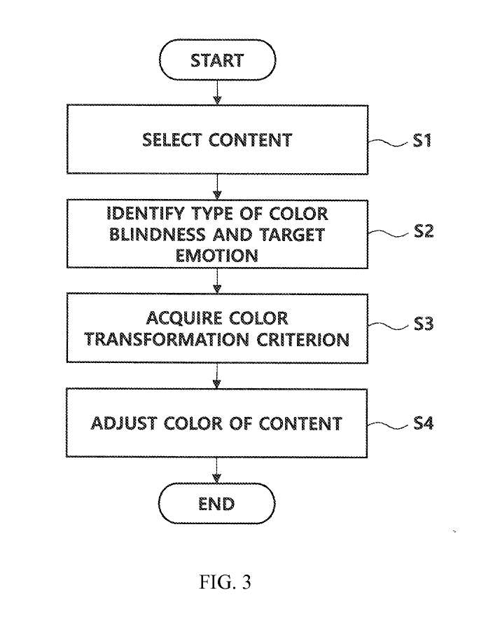

Hereinafter, a detailed description of a method for color adjustment of content according to an exemplary embodiment of the present disclosure is provided with reference to FIG. 3.

First, when a content desired to play is selected (S1), a type of color blindness of a user and a target emotion is identified by asking it to the user who will see the corresponding content (S2). In this instance, the target emotion may be automatically obtained through a content analysis operation.

Also, among color transformation criteria stored in the color transformation criteria DB 10, a color transformation criterion corresponding to the type of color blindness of the user and the target emotion is acquired (S3), and based on the color transformation criterion acquired through S3, the color of the content is adjusted entirely or selectively (S4).

Accordingly, when people with color blindness see the color-adjusted content, they always feel distortion-free emotions from the content irrespective of their types of color blindness.

Also, through the content color adjusting operation as shown in FIG. 3, emotions people feel when they see the content may be compelled or amplified to some extent. For example, when an emotion representing the content is a sad emotion, an emphasis is placed on purple corresponding to a sad emotion to force people seeing the corresponding content to feel sad more easily, and in contrast, when an emotion representing the content is fear/thrill, an emphasis is placed on blue-green corresponding to a reluctant emotion to stimulate the fear of people seeing the corresponding content more strongly.

Further, when transforming a particular color in the content, the present disclosure may transform a surrounding color of the corresponding color together. That is, the present disclosure may pre-define and register surrounding color transformation criteria corresponding to each of combinations of a color to be transformed and a surrounding color and surrounding area setting criteria (for example, an area size) based on emotions and types of color blindness, and based on this, when transforming a particular color, may transform a surrounding background color of the corresponding color together.

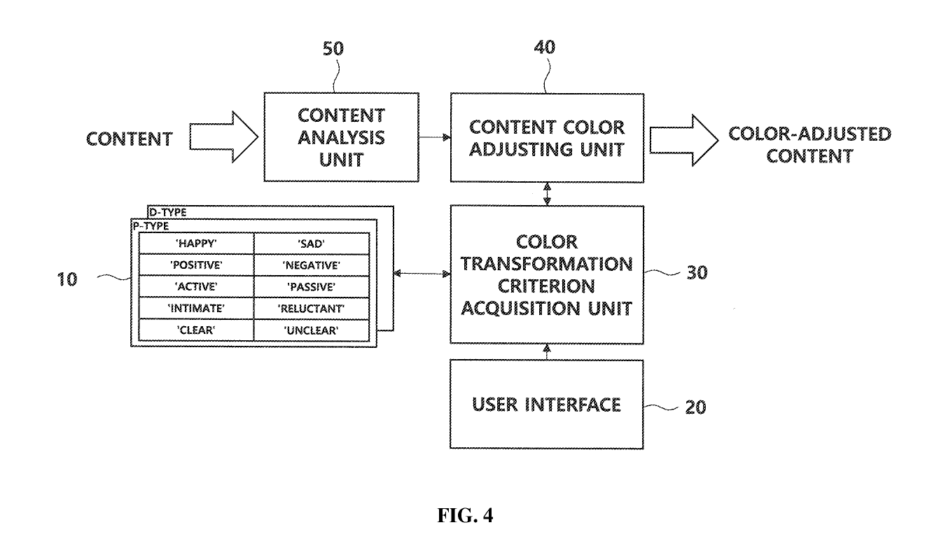

FIG. 4 is a diagram illustrating an apparatus for color adjustment of content according to another exemplary embodiment of the present disclosure.

The apparatus for color adjustment of content as shown in FIG. 4 performs a content color adjusting operation differently for each section of the content, and further includes a content analysis unit 50 dissimilar to the apparatus for color adjustment of content as shown in FIG. 1.

For reference, in the case of content such as a movie, even though the content is the same content, contents having different emotions may be provided for each section of the content. However, current technology fails to divide the content into a plurality of sections and notify representative emotions corresponding to each of the sections.

Thus, the present disclosure divides an overall section of the content into a plurality of sections based on a content of the content through the content analysis unit 50, and derives emotions representing each of the plurality of sections, to perform the content color adjusting operation differently for each section.

The content analysis unit 50 of the present disclosure performs a section classification operation by collecting and analyzing color distributions of each of constituent images for the content. That is, when images with a color distribution representing happiness are consecutively provided, a corresponding section is classified as a first section, and subsequent to the first section, when images with a color distribution representing reluctance are consecutively provided, a corresponding section is classified as a second section, and in this way, the section classification operation will be performed.

Also, the section classification operation may be performed by collecting and analyzing metabolic information corresponding to each of the constituent images for the content. That is, the section classification operation may be performed in a manner of classifying a section where words representing happiness are mainly used as a first section, and classifying a section where words representing reluctance are mainly used as a second section.

Subsequently, the color transformation criterion acquisition unit 30 acquires a plurality of color transformation criteria in consideration of the emotions representing each of the plurality of sections and the type of color blindness of the user, and using these, the content color adjusting unit 40 adjusts the color of the content differently for each section.

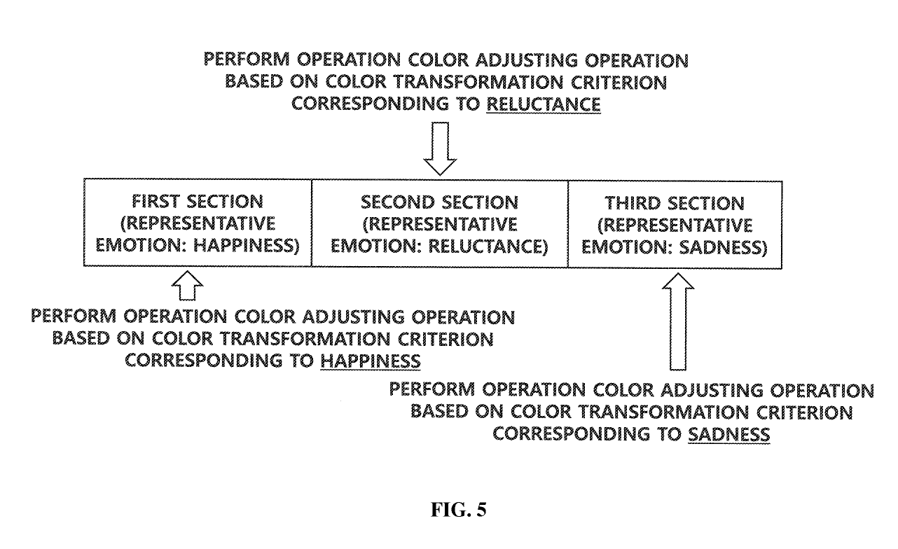

For example, as shown in FIG. 5, assume that the content is divided into a first section, a second section, and a third section, and the first section has happiness as a representative emotion value, the second section has reluctance as a representative emotion value, and the third section has sadness as a representative emotion value, the color transformation criterion acquisition unit 30 acquires three color transformation criteria corresponding to happiness, reluctance, and sadness, and using these, the content color adjusting unit 40 will perform a color adjusting operation on the content of the first section based on the color transformation criterion corresponding to happiness, the content of the second section based on the color transformation criterion corresponding to reluctance, and the content of the third section based on the color transformation criterion corresponding to sadness.

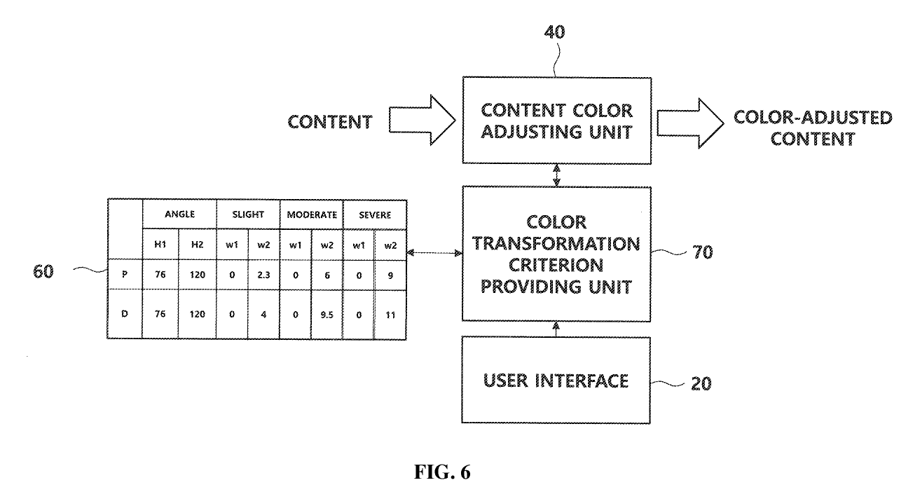

FIG. 6 is a diagram illustrating an apparatus for color adjustment of content according to still another exemplary embodiment of the present disclosure, which provides a common color transformation criterion for minimizing an emotional distortion, and through this, adjusts the content color at one time.

As shown in FIG. 6, the apparatus for color adjustment of content according to the present disclosure includes color transformation criteria DB 60 and a color transformation criterion acquisition unit 70 in place of the color transformation criteria DB 10 and the color transformation criterion acquisition unit 30 of FIG. 1.

Hereinafter, a description of functions of each component is provided as below.

The color transformation criteria DB 60 defines and stores common color transformation criteria for minimizing an emotional distortion for each type of color blindness and for each degree of color blindness.

The following Table 3 is a table showing common color transformation criteria corresponding to people with P-type color blindness and D-type color blindness, in which H1 denotes a color before transformation, H2 denotes a color after transformation, w1 denotes a color weight before transformation, and w2 denotes a color weight after transformation. Also, the degree of color blindness may be classified into slight, moderate, and severe.

TABLE 3

| Type of | | | | | | | | |
|---|---|---|---|---|---|---|---|---|
| color | Angle | | Slight | | Moderate | | Severe | |
| blindness | H1 | H2 | w1 | w2 | w1 | w2 | w1 | w2 |
| P-type | 76 | 120 | 0 | 2.3 | 0 | 6 | 0 | 9 |
| D-type | 76 | 120 | 0 | 4 | 0 | 9.5 | 0 | 11 |

The data input unit 20 has a user interface such as a keyboard and a touch screen to allow a user to perform a data input operation, and through this, obtain information associated with a type of color blindness and a degree of color blindness of the user.

The color transformation criterion acquisition unit 70 has a basic color transformation equation such as Equation 1 below. Also, when information associated with the type of color blindness and the degree of color blindness of the user is inputted through the data input unit 20, the color transformation criterion acquisition unit 70 obtains a corresponding common color transformation criterion by searching the color transformation criteria DB 10 and applies it to the color transformation equation, thereby acquiring and providing a color transformation equation corresponding to the type of color blindness of the user as a color transformation criterion.

$${Hue}_{shift} = {Hue}_{row} + C \\ C = m \times ( {Hue}_{row} - H 1 ) + w 1 \\ m = \frac{( w 2 - w 1 )}{( H 2 - H 1 )} \qquad [ Equation 1 ]$$

In this instance, Hue_{row} denotes an angle of color before transformation, and Hue_{shift} denotes an angle of color after transformation.

That is, when the user has slight P-type color blindness, a color transformation equation

$${ }^{``} {Hue}_{shift} = {Hue}_{row} + \frac{2.3}{44} \times {( {Hue}_{row} - 76 )}^{″}$$

is acquired and provided as the color transformation criterion, when the user has moderate P-type color blindness, a color transformation equation

$${ }^{``} {Hue}_{shift} = {Hue}_{row} + \frac{6}{44} \times {( {Hue}_{row} - 76 )}^{″}$$

is acquired and provided as the color transformation criterion, and when the user has severe P-type color blindness, a color transformation equation

$${ }^{``} {Hue}_{shift} = {Hue}_{row} + \frac{9}{44} \times {( {Hue}_{row} - 76 )}^{″}$$

is acquired and provided as the color transformation criterion.

Also, when the user has slight D-type color blindness, a color transformation equation

$${ }^{``} {Hue}_{shift} = {Hue}_{row} + \frac{4}{44} \times {( {Hue}_{row} - 76 )}^{″}$$

is acquired and provided as the color transformation criterion, when the user has moderate D-type color blindness, a color transformation equation

$${ }^{``} {Hue}_{shift} = {Hue}_{row} + \frac{9.5}{44} \times {( {Hue}_{row} - 76 )}^{″}$$

is acquired and provided as the color transformation criterion, and when the user has severe D-type color blindness, a color transformation equation

$${ }^{``} {Hue}_{shift} = {Hue}_{row} + \frac{11}{44} \times {( {Hue}_{row} - 76 )}^{″}$$

is acquired and provided as the color transformation criterion.

The content color adjusting unit 40 adjusts the color in the content using the color transformation equation provided by the color transformation criterion acquisition unit 70. However, the content color adjusting operation may be performed on the entire content at one time, and may be selectively performed on an object selected by the user. In this instance, the object may be various types of characters and objects, and a background included in the content.

The disclosure set forth hereinabove may be embodied as a program code for implementation, and a computer-readable recording medium recording the program code readable by a computer includes, for example, read-only memory (ROM), random access memory (RAM), compact disc read-only memory (CD-ROM), magnetic tapes, floppy discs, optical data recording devices, and the like.

Also, the computer-readable recording medium recording the program may be distributed over network-coupled computer systems so that the computer-readable code is stored and executed in a distributed fashion. In this case, at least one of the distributed computers may execute some of the functions presented as above and transmit its execution result to at least one of the other distributed computers, and a computer receiving the result may also execute some of the functions presented as above and transmit its result to the other distributed computers.

The computer able to read the recording medium recording an application made with the program code for operating the method for color adjustment of content according to each embodiment of the present disclosure includes general PCs such as desktop computers or laptop computers as well as mobile terminals such as smart phones, tablet PCs, personal digital assistants (PDAs) and mobile communication terminals, and it should be interpreted that the computer may include all devices capable of computing.

While all components constituting the embodiments of the present disclosure are described hereinabove as being coupled into one or operating while coupled, the present disclosure is not necessarily limited to such embodiments. That is, within the objective scope of the present disclosure, the components may operate in a selectively coupled manner of at least one of them. Also, each of the components may be implemented as a single independent hardware, but may be implemented as a computer program having a program module that is composed of a selective combination of some or all of the components and performs some or all of functions of the combinations in one or more hardware. Also, codes and code segments constituting the computer-readable code may be easily inferred by one of ordinary skill in the art. The computer-readable code is stored in a computer-readable medium and is read and executed by a computer system, to implement the exemplary embodiments of the present disclosure. The recording medium of the computer-readable code may include a magnetic recording medium, an optical recording medium, and the like.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus for color adjustment of content comprising:
a color transformation criteria database storing and managing color transformation criteria corresponding to each of combinations of types of color blindness and emotions;
a data input unit obtaining a type of color blindness of a user and information associated with a target emotion;
a color transformation criterion acquisition unit acquiring a color transformation criterion corresponding to the type of color blindness of the user and the target emotion by searching the color transformation criteria database; and
a content color adjusting unit performing a content color adjusting operation based on the acquired color transformation criterion.

2. The apparatus for color adjustment of content of claim 1, wherein the color transformation criteria database further includes a function of storing and managing surrounding color transformation criteria corresponding to each of color combinations for each emotion and each type of color blindness.

3. The apparatus for color adjustment of content of claim 2, wherein the content color adjusting unit transforms a color to be transformed and a surrounding color of the color to be transformed together, based on the surrounding color transformation criteria corresponding to each of color combinations.

4. The apparatus for color adjustment of content of claim 1, wherein the color transformation criteria database further includes a function of storing and managing common color transformation criteria for each type of color blindness.

5. The apparatus for color adjustment of content of claim 4, wherein the color transformation criterion acquisition unit acquires and provides, as the common color transformation criteria, a color transformation equation
$${ }^{``} {Hue}_{shift} = {Hue}_{row} + \frac{2.3}{44} \times {( {Hue}_{row} - 76 )}^{″}$$
when the user has slight P-type color blindness, a color transformation equation
$${ }^{``} {Hue}_{shift} = {Hue}_{row} + \frac{6}{44} \times {( {Hue}_{row} - 76 )}^{″}$$
when the user has moderate P-type color blindness, a color transformation equation
$${ }^{``} {Hue}_{shift} = {Hue}_{row} + \frac{9}{44} \times {( {Hue}_{row} - 76 )}^{″}$$
when the user has severe P-type color blindness, a color transformation equation
$$“ {Hue}_{shift} = {Hue}_{row} + \frac{4}{44} \times ( {Hue}_{row} - 76 ) ”$$
when the user has slight D-type color blindness, a color transformation equation
$$“ {Hue}_{shift} = {Hue}_{row} + \frac{9.5}{44} \times ( {Hue}_{row} - 76 ) ”$$
when the user has moderate D-type color blindness, and a color transformation equation
$$“ {Hue}_{shift} = {Hue}_{row} + \frac{11}{44} \times ( {Hue}_{row} - 76 ) ”$$
when the user has severe D-type color blindness,
where Hue_{row} denotes a color before transformation, and Hue_{shift} denotes a color after transformation.

6. The apparatus for color adjustment of content of claim 1, further comprising:
a content analysis unit receiving and analyzing the content, dividing the content into a plurality of sections based on a content of the content, and deriving emotions representing each of the plurality of sections.

7. The apparatus for color adjustment of content of claim 6, wherein the color transformation criteria database further includes a function of storing and managing surrounding color transformation criteria corresponding to each of color combinations for each emotion and each type of color blindness.

8. The apparatus for color adjustment of content of claim 7, wherein the content color adjusting unit transforms a color to be transformed and a surrounding color of the color to be transformed together, based on the surrounding color transformation criteria corresponding to each of color combinations.

9. The apparatus for color adjustment of content of claim 6, wherein the color transformation criteria database further includes a function of storing and managing common color transformation criteria for each type of color blindness.

10. The apparatus for color adjustment of content of claim 9, wherein the color transformation criterion acquisition unit acquires and provides, as the common color transformation criteria, a color transformation equation
$$“ {Hue}_{shift} = {Hue}_{row} + \frac{2.3}{44} \times ( {Hue}_{row} - 76 ) ”$$
when the user has slight P-type color blindness, a color transformation equation
$$“ {Hue}_{shift} = {Hue}_{row} + \frac{6}{44} \times ( {Hue}_{row} - 76 ) ”$$
when the user has moderate P-type color blindness, a color transformation equation
$$“ {Hue}_{shift} = {Hue}_{row} + \frac{9}{44} \times ( {Hue}_{row} - 76 ) ”$$
when the user has severe P-type color blindness, a color transformation equation
$$“ {Hue}_{shift} = {Hue}_{row} + \frac{4}{44} \times ( {Hue}_{row} - 76 ) ”$$
when the user has slight D-type color blindness, a color transformation equation
$$“ {Hue}_{shift} = {Hue}_{row} + \frac{9.5}{44} \times ( {Hue}_{row} - 76 ) ”$$
when the user has moderate D-type color blindness, and a color transformation equation “
$${Hue}_{shift} = {Hue}_{row} + \frac{11}{44} \times ( {Hue}_{row} - 76 ) ”$$
when the user has severe D-type color blindness,
where Hue_{row} denotes a color before transformation, and Hue_{shift} denotes a color after transformation.

11. The apparatus for color adjustment of content of claim 1, wherein the content color adjusting unit further includes a function of differing in the color transformation criteria corresponding to each of the plurality of sections based on emotions representing each of the plurality of sections.

12. A method for color adjustment of content comprising:
identifying a type and a degree of color blindness of a user, and acquiring a common color transformation criterion corresponding to the identified type and degree of color blindness; and
adjusting and outputting the color of an inputted content based on the acquired common color transformation criterion.

13. The method for color adjustment of content of claim 8, wherein the acquiring of the common color transformation criterion comprises acquiring and providing, as the common color transformation criterion, a color transformation equation
$$“ {Hue}_{shift} = {Hue}_{row} + \frac{2.3}{44} \times ( {Hue}_{row} - 76 ) ”$$
when the user has slight P-type color blindness, a color transformation equation
$$“ {Hue}_{shift} = {Hue}_{row} + \frac{6}{44} \times ( {Hue}_{row} - 76 ) ”$$
when the user has moderate P-type color blindness, a color transformation equation
$$“ {Hue}_{shift} = {Hue}_{row} + \frac{9}{44} \times ( {Hue}_{row} - 76 ) ”$$
when the user has severe P-type color blindness, a color transformation equation
$$“ {Hue}_{shift} = {Hue}_{row} + \frac{4}{44} \times ( {Hue}_{row} - 76 ) ”$$
when the user has slight D-type color blindness, a color transformation equation
$$“ {Hue}_{shift} = {Hue}_{row} + \frac{9.5}{44} \times ( {Hue}_{row} - 76 ) ”$$
when the user has moderate D-type color blindness, and a color transformation equation
$$“ {Hue}_{shift} = {Hue}_{row} + \frac{11}{44} \times ( {Hue}_{row} - 76 ) ”$$
when the user has severe D-type color blindness,
where Hue_{row} denotes a color before transformation, and Hue_{shift} denotes a color after transformation.
